(19) United States
(12) Patent Application Publication
(10) Pub. No.: US 2008/0309116 A1
(43) Pub. Date: Dec. 18, 2008

(54) Folding Top For an Open Motor Vehicle

(75) Inventor: Michael Koch, Boeblingen (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/065,137

(22) PCT Filed: Aug. 3, 2006
(86) PCT No.: PCT/EP2006/007685

§ 371 Date: Aug. 28, 2008

(30) Foreign Application Priority Data
Aug. 31, 2005 (DE) 10 2005 041 220.3

(51) Int. Cl. B60J 7/12

(52) U.S. Cl. 296/107.01

(57) ABSTRACT

A folding top for an open motor vehicle adjustable between a closed position covering the passenger cell and a folded storage position in which the folding top and is accommodated in a folding-top storage space. In order to adjust the folding top, a control linkage is provided on both sides of the motor vehicle and has two main links that are supported on an associated bracket via a respectively assigned main bearing. At least one main bearing of each control linkage is movable in relation to either or both of the associated bracket and in relation to the assigned main link.

### CROSS REFERENCE TO RELATED APPLICATIONS

This application is a U.S. National Phase Entry under 35 U.S.C. § 371, of PCT Application PCT/EP2006/007685, filed internationally on Aug. 3, 2006, which claims priority to German patent application No. DE 10 2005 041 220.3, filed Aug. 31, 2005. Priority to each of these applications is claimed under 35 U.S.C. §§ 119 and 120, and the disclosures thereof are hereby incorporated by reference in their entirety.

### BACKGROUND AND SUMMARY OF THE INVENTION

The present invention relates to a folding top for an open motor vehicle.

DE 199 60 010 C1 has already disclosed a folding top which is adjustable between a closed position covering the passenger cell and a folded storage position. The known folding top already reaches the folded storage position at a vertical distance above the folding-top storage space, from where the folding top can be accommodated by being lowered into its final storage position within the folding-top storage space. In the open motor vehicle shown there, the upper region of the trunk compartment serves as the folding-top storage space. The associated rear cover can be opened in a direction opposed to its normal opening direction during the lowering of the folding top. In order to load the trunk compartment, the folding top which is folded into its storage space can also be brought out of the position in which it is accommodated in the folding-top storage space or trunk compartment into the previously described position in which it is located at a vertical distance thereabove. In order to adjust the folding top between its closed position and its folded storage position, use is made of control linkages which are arranged on both sides of the motor vehicle and are designed there as “parallelogram linkages.” Each of the control linkages is supported on an associated bracket of the motor vehicle body via two main bearings in each case. The brackets serve in addition to fasten the folding top which is preferably preassembled away from the motor vehicle and is subsequently fixed on the motor vehicle body via the brackets. In order to displace the folding top, when in its folded storage position, from the vertical distance above the folding-top storage space into the latter, each of the two brackets is pivotable about a pivot axis running in the transverse direction of the vehicle. In this case, the pivoting adjustment and securing of the brackets are taken on by respectively assigned hydraulic cylinders.

The pivoting mounting of the two brackets in the above-described known arrangement has to be configured to be extremely solid and, furthermore, the hydraulic cylinders for the pivoting adjustment and for the securing of the two brackets, or of the entire folding top, have to be extremely stable and robust.

It is therefore an object of the present invention to structurally simplify the folding-top parts necessary for mounting the aforementioned folding top at in its folded storage position.

This object has been achieved according to the invention by a folding top for an open motor vehicle in which at least one main bearing of each control linkage is configured to be movable in relation to at least one of the associated bracket and the associated main link.

In the folding top according to the invention, at least one main bearing of each control linkage is movable in relation to either or both of the associated bracket and the assigned main link. Thereby, it is no longer necessary, in comparison to the prior art approach, in each case to pivotably mount all of the lateral brackets so as to displace the folding top in its folded storage position. On the contrary, the brackets can now remain fixed on the motor vehicle body and only at least one main bearing is moved in relation to the associated bracket or in relation to the assigned main link. The second main bearing in each case then preferably acts as a pivot axis about which the respective control linkage or, ultimately, the entire folding top is pivoted.

The movable main bearing can be displaced, for example, along a control path, or else can be adjusted in its position by a sliding guide, a mounting or a pivoting and sliding mounting in a simple and technically easily controllable manner. If the two movable main bearings are guided within a control path, then, in order to adjust each bracket, it is possible, for example, to omit the prior art second hydraulic cylinder. On the contrary, the movable main bearing then runs along a control path in accordance with the lowering movement of the folding top. As a result, the lowering or lifting movement of the folding top, in its folded storage position, from an upper position into the position in which it is accommodated in the folding-top storage space can also be realized.

To assist the lowering and lifting movement, a spring device which assists the movement of the corresponding main bearings along the control path may also be provided. It is also contemplated to move the movable main bearings by associated adjusting elements. Since, according to the invention, only the main bearings are now to be moved, the respective adjusting element can be produced such that it is extremely small and structurally simple.

It has proven particularly advantageous to design the front main bearings in each case of each control linkage to be height-adjustable in relation to the associated bracket. The rear main bearings in each case preferably remain in situ and the pivot axes of the control linkage or of the entire folding top for the displacement thereof forming in the folded storage position. This makes it possible to define a precise pivot axis which runs through the two rear main bearings.

When the movable main bearings are adjusted along a control path, a particularly simple and easily controllable guidance of the moving main bearings is achieved. An arc-shaped sliding guide allows the two non-moving main bearings of each control linkage to remain in situ on the associated bracket or the motor vehicle body.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic side view of part of an open motor vehicle with a folding top in its closed position;

FIG. 2 is a schematic side view of part of the motor vehicle according to FIG. 1, but now with the folding top thereof being transferred from its closed position into a folded storage position;

FIG. 3 is a schematic side view of part of the motor vehicle shown in FIGS. 1 and 2, but now with the folding top having reached its folded storage position at a vertical distance above the folding-top storage space;

FIG. 4 is a schematic side view of part of the motor vehicle shown in FIGS. 1 to 3, but now with the folding top being accommodated in its folded storage position within the closed folding-top storage space;

FIG. 5 is a schematic side view of part of the motor vehicle shown in FIGS. 1 to 4, but now with the folding top being accommodated in its folded storage space within the storage space or trunk compartment;

FIG. 6 is a schematic side view of part of the motor vehicle shown in FIGS. 1 to 5, but now with the folding top being displaced in its folded storage position to a distance above the folding-top storage space for the loading of the trunk compartment;

FIG. 7 is a schematic side view of the folding shown in FIGS. 1 to 6 in its closed position, but now with one of the two control linkages for the adjustment of the folding top being shown;

FIG. 8 is a schematic side view of the folding top shown in FIG. 7 but now in a semi-open state;

FIG. 9 is a schematic side view of the folding top shown in FIGS. 7 and 8 in its folded storage position in which the folding top is now arranged at a distance above its position in which it is accommodated in the trunk compartment; and

FIG. 10 is a schematic side view of the folding top shown in FIGS. 7 to 9 in its folded storage position in which the folding top is now accommodated within the folding-top storage space.

### DETAILED DESCRIPTION OF THE DRAWINGS

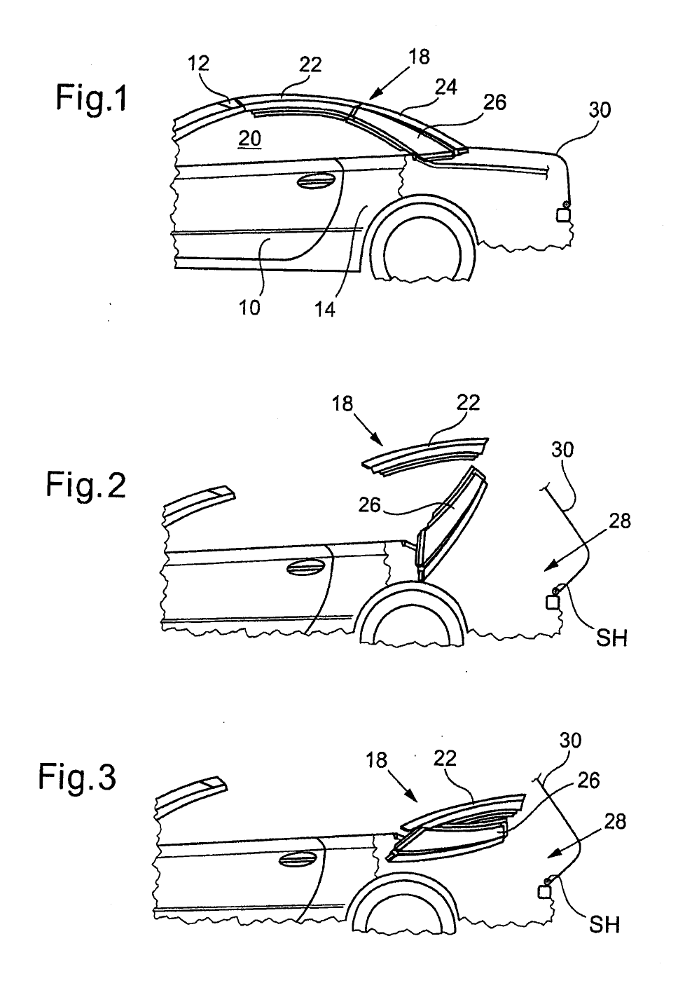

FIG. 1 shows an open motor vehicle such as a roadster with a row of vehicle seats. Essentially part of a side door 10, a windshield frame 12, a rear wing 14, a rear lid 30 and a folding top 18, which here takes up a closed position covering the passenger cell 20 of the open motor vehicle, are shown. In the present illustrated embodiment, the folding top 18 is configured as a “hard top” with a roof part 22 and a rear window part 26 bearing a rear window 24. The roof part 22 and the rear window part 26 are fixed shell-shaped elements made of sheet metal, plastic or glass which are sealed off from one another and from the vehicle body along sealing joints (not illustrated).

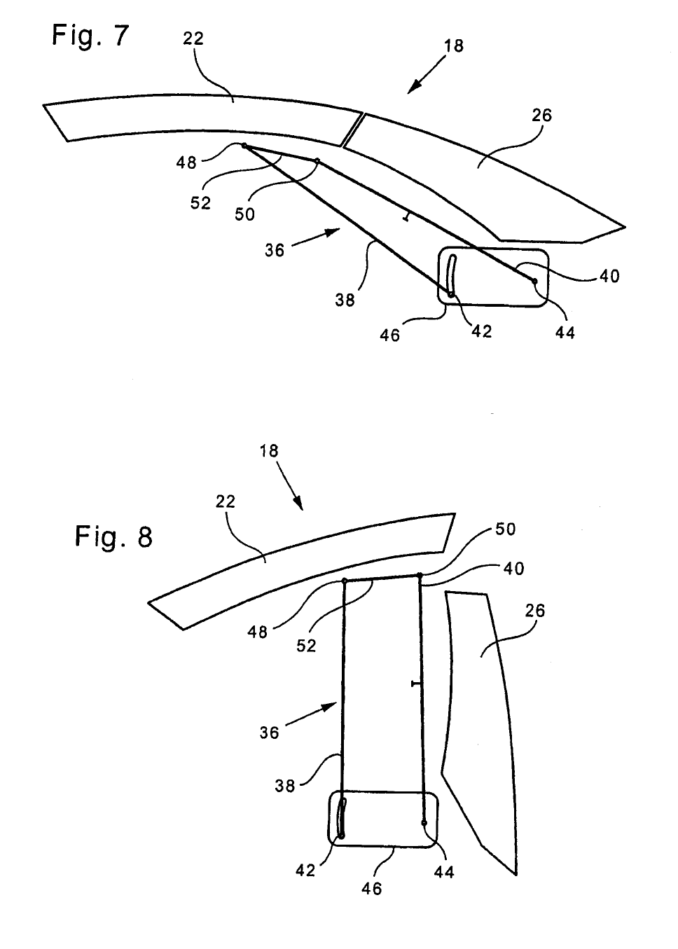

FIG. 2 illustrates the folding top 18 in an intermediate position during the opening or closing operation. The folding top 18 is to be accommodated in the customary manner in a folding-top storage space 28 which, in the present embodiment, is a substantial upper part of the trunk compartment of the motor vehicle and can be separated from the latter, for example by a known type of covering blind (not illustrated) or a covering hood. The folding-top storage space 28 or the trunk compartment is closed by a rear lid 30 which, during the putting-away of the folding top 18, is to be opened about a pivot axis SH, which runs in the transverse direction of the vehicle, in the opposite direction to its customary opening direction for the loading of the trunk compartment. In FIG. 2, the rear lid 30 is shown in its position in which it is pivoted to the rear about the pivot axis SH. The folding mechanism of the folding top 18 with its pivot axis, which is fixed on the bodywork, for the rear window part 26 and the pivot axis between the roof part 22 and the rear window part 26 will be explained in more detail with reference to FIGS. 7 to 10.

FIG. 3 shows the folding top 18 having reached a folded storage position. In this position, the roof part 22 and the rear window part 26 have at least substantially reached their final folded position with respect to each other. The rear window 24 remains in a fixed position within the rear window part 26; however, it is also contemplated that a rear pane 24 which turns in the opposite direction can be used as is shown, for example, from DE 197 51 660 C1, the contents of which are incorporated by reference herein.

The folding top 18 reaches the folded storage position in the position illustrated in FIG. 3, i.e. at a vertical distance above that storage position in which the folding top 18 is completely accommodated within the folding-top storage space. The folded storage position is therefore already reached outside the folding-top storage space 28, with advantage being taken here of the recognition that the pivoting movement of the individual parts of the folding top 18, i.e., in particular, of the roof part 22 and of the rear window part 26, requires considerable clearances. Since experience has shown that the clearances within the motor vehicle are very difficult to provide, the folding movement of the folding top 18 until the folded storage position is reached is therefore carried out outside the motor vehicle.

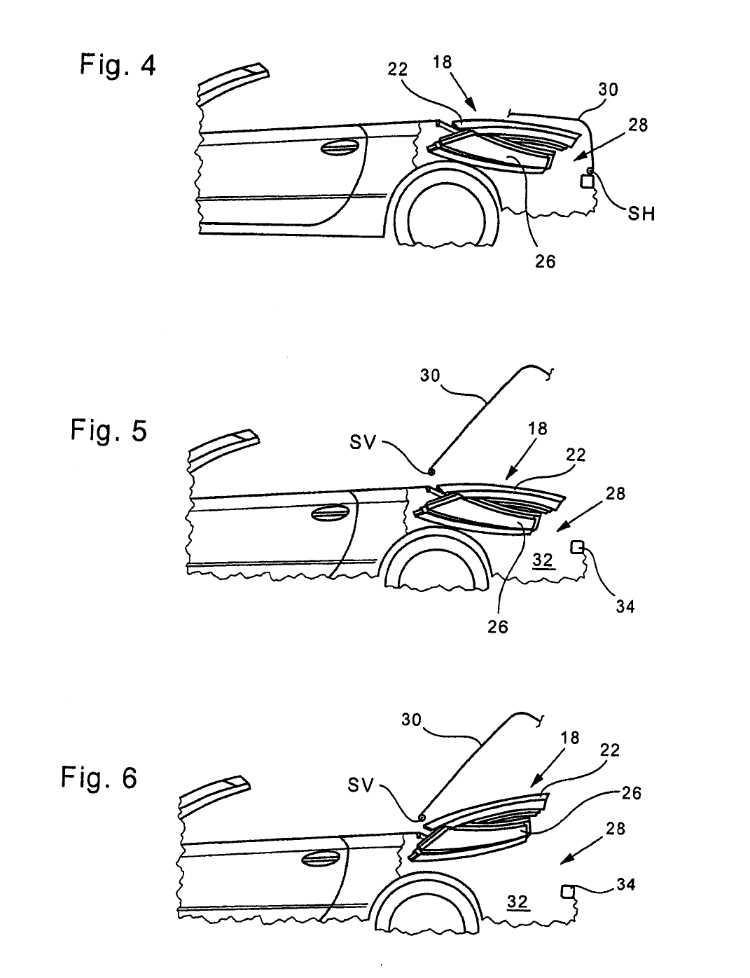

FIG. 4 shows the folding top 18, which is folded into its storage position, now being accommodated within the folding-top storage space 28. Accordingly, after the end of the folding operation, the rear lid 30 has been pivoted back again into its closed position from its position shown in FIGS. 2 and 3 in which it has been displaced back about the pivot axis SH. The folding top 18, which is folded into its storage position in FIG. 3, however, has previously been put away in a positionally secure manner via a lowering movement (described further on) from the position which is illustrated in FIG. 3 into its storage position, illustrated in FIG. 4, within the folding-top storage space 28. For this lowering movement out of the position shown in FIG. 3 into the position shown in FIG. 4, relatively little clearance is required in front of or behind the folding top 22. Accordingly, the folding-top storage space 28 can be made relatively narrow.

FIGS. 5 and 6 show the rear lid 30 open about a front pivot axis SV that runs in the transverse direction of the vehicle for loading of the trunk compartment. The residual trunk compartment 32, which is minimized by the folding-top storage space 28 when the folding top 18 is put away, is located essentially below the roof part 22 or the rear window part 26 and is accessible via a clearance between a loading edge 34 and the folding top 18.

Of course, such clearance is sufficient for smaller objects, such as umbrellas, shoes or the like. In order to make the residual trunk compartment easily accessible even for larger objects, such as, for example, bags or boxes, however, the folding top 18 can be transferred into a “loading position” which is illustrated in FIG. 6. This loading position corresponds to the folded storage position taken up by the folding top in FIG. 3 during opening—and conversely also during closing—of the folding top 18. In other words, in the folded storage position of FIG. 6, the folding top 18 has been displaced by a vertical distance upward out of its storage position located within the folding-top storage space 28, with the height of lift of the folding top 18 according to FIG. 6 corresponding to that in FIG. 3.

The transfer of the folding top 18 from the position illustrated in FIG. 5 into the same according to FIG. 6 can take place, for example, via a switch which is arranged in the region of the loading edge 34. After the residual trunk compartment 32 is loaded, the folding top can then be lowered from the position illustrated in FIG. 6 back into the position illustrated in FIG. 5 and the rear lid 30 can be closed.

In the illustrated motor vehicle, the folding top 18, in its folded storage position, is therefore located at least partially outside the folding-top storage space 18 under two conditions, namely in one case as seen in FIG. 3 to carry out the folding up or folding back of the roof parts 22, 26 at least partially outside of the folding-top storage space 28, and in the other case as seen in FIG. 6 to simplify the loading of the residual trunk compartment 32. It will be clear to one of ordinary skill in this art that the two functions are not necessarily linked to each other. For example, an open motor vehicle would likewise also be producible in which the folding top 18 is to be brought outside the folding-top storage space 28 only for loading purposes or for folding into its folded storage position.

FIGS. 7 to 10 show only the folding top 18 without the motor vehicle body, in order to explain the operation of the folding mechanism. The roof part 22 and the rear window part 26 are connected to each other via a respective control linkage designated generally by numeral 36 which is arranged on both sides of the motor vehicle to adjust the folding top 18. In the illustrated embodiment, the control linkage 36 operates essentially as a “parallelogram linkage”comprising a front main link 38 and a rear main link 40. The two main links 38, 40 on the two sides of the folding top 18 are supported on an associated lateral bracket 46 via a respectively associated front and rear main bearing 42, 44. The folding top 18 is held as a whole on the motor vehicle body via the two brackets 46 which are assigned laterally to the respective control linkage 36. Those ends of the two main links 38, 40 which lie opposite the two lower main bearings 42, 44 each comprise a point of articulation or bearing point 48, 50 at which the two main links 38, 40 are connected to an intermediate link 52.

The intermediate link 52 is connected fixedly to the roof part 22. It would likewise also be conceivable, however, instead of using the intermediate link 52, to mount the two points of articulation 48, 50 of the two main links 38, 40 directly on the roof part 22. The rear main link 40 is connected fixedly to the rear window part 26. It would likewise also be conceivable that the rear window part 26 replaces the rear main link 40 at least in some sections such as in a central section. For example, the point of articulation 50 could also be realized by a hinge part fastened directly to the rear window part 26. Likewise, an articulated arm which comprises the respectively associated rear main bearing 44 could be provided at the lower end of the rear window part 26.

The operation of the two control linkages 36 can be seen in an overall view with FIG. 8 which shows the folding top 18 approximately in the same position as seen in FIG. 2. During the opening of the folding top 18, the rear main link 40 is pivoted in the clockwise direction about the rear main bearing 44 via a conventional type of actuating element such as, for example, a hydraulic cylinder or a linear motor (and therefore not illustrated). The rear window part 26 which is connected fixedly to the rear main link 40 is accordingly likewise moved. In addition, the two links i.e., the main link 38 and the intermediate link 52, are carried along via the parallelogram-like control linkage 36. In this case, the position of the roof part 22 in relation to the rear window part 26 is determined by the position of the intermediate link 52 in relation to the main link 40.

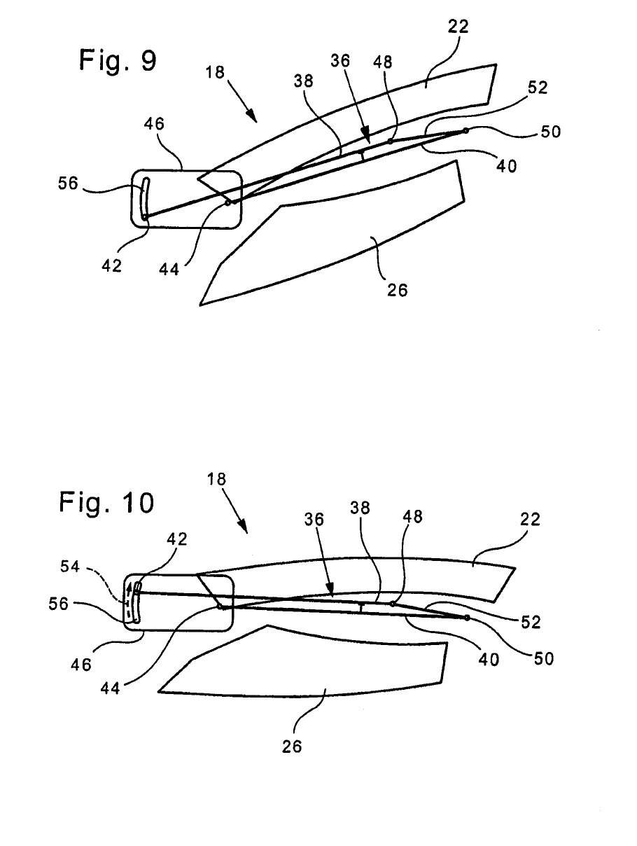

FIG. 9 shows the folded storage position of the folding top 18 essentially as illustrated in FIGS. 3 and 6, namely at the vertical distance in relation to the storage position which the folding top 18 takes up when it is accommodated in the folding-top storage space 28. The roof part 22 and the rear window part 26 are therefore arranged in a position with respect to each other such as they also take up in their storage position within the folding-top storage space 28. The aforementioned adjusting element moves the main link 40 further in the clockwise direction out of the position shown in FIG. 8. As a result the parallelogram-like control linkage 36 has likewise been entrained by the intermediate link 52 and the main link 38. The position of the rear window part 26 and of the roof part 22 is respectively determined in each case by the position of the lateral intermediate links 52 and the lateral main links 40.

Finally, FIG. 10 shows the folding top 18 in its storage position in which it is inserted within the folding-top storage space 28, as can already be seen in FIGS. 4 and 5. It can be seen that the folded storage position of the roof part 22 and of the rear window part 26 has remained unchanged between the inserted storage position illustrated in FIG. 10, and the loading position of the folding top 18 arranged at a vertical distance above the storage position in FIG. 9.

The lowering of the folding top 18 is brought about by the front main bearing 42 in each case of the two controlling linkages 36 being displaced upward on both sides of the motor vehicle in relation to the associated bracket 46. For this purpose, a respective control path 56 along which the associated front main bearing 42 can be moved is provided in the brackets 46 arranged on both sides.

It can be appreciated from FIGS. 7 to 9 that, over the course of the folding of the folding top 18, the respective front main bearing 52 remains in a lower height position within the control path 56 between the closed position and the position at a vertical distance above the folding-top storage space 28. During the lowering of the folding top 18 from the height position above the folding-top storage space 28 into the storage position located in the folding-top storage space 28, the main bearing 42 is then displaced into an upper height position within the control path 56 as seen in FIG. 10. By contrast, the rear main bearing 44 in each case of the rear main link 40 remains fixed in position on the bracket 46 or on the motor vehicle body. During a vertical displacement of the main bearing 42 out of the position according to FIG. 9 into that according to FIG. 10 and vice-verse a pivoting movement of the folding top 18 downward accordingly takes place.

In the illustrated embodiment, the control path 56 is an essentially arc-shaped sliding guide, the radius of which is matched to the pivoting movement of the front main bearing 42. By way of a simple vertical displacement of the front main bearings 42 provided on both sides, the loading position shown in FIG. 6 can therefore also be reached, with it being possible for the control path 56 to be designed in such a manner that no additional adjusting elements, such as hydraulic cylinders, are required for moving the front main bearings 42 within the control path 56. This can be achieved, for example, by a suitably shaped slotted guide. However, it is likewise also contemplated for the two front main bearings 42 to be able to be adjusted and held in the adjusted position by means of small and compact adjusting elements or hydraulic cylinders. The movement of the two front main bearings 42 within the control path 56 can also be assisted or damped by a spring force.

In another embodiment, the main bearing 42 may also be movable in relation to the assigned main link 38. For this purpose, a control path which is designed corresponding to the control path 56 can be provided within the main link 38. Of course, other guides or mountings would also be employable for this. In other words, the main bearing 42 can be held fixedly on the bracket 46 and moved relative to the main link 38. In a further embodiment, the main bearing 42 can be movable both in relation to the bracket 46, for example by way of the control path 56, and also in relation to the main link 38 by way, for example, of a further control path within the main link 38.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A folding top for an open motor vehicle, which is adjustable between a closed position covering the passenger cell and a folded storage position in which the folding top (18) is to be accommodated in a folding-top storage space, wherein, in its folded storage position, the folding top (18) is displaceable in relation to the motor vehicle, and wherein, in order to adjust the folding top (18), a respective control linkage (36) is provided on both sides of the motor vehicle and has two main links (38, 40) which are supported on an associated bracket (46) of the motor vehicle body via a respectively assigned main bearing (40, 42), characterized in that at least one main bearing (42) of each control linkage (36) is designed to be movable in relation to the associated bracket (46) and/or in relation to the associated main link (38).

2. The folding top as claimed in claim 1, characterized in that a front main bearing (42) in each case of each control linkage (36) is designed to be height-adjustable in relation to the associated bracket (46).

3. The folding top as claimed in claim 1, characterized in that a rear main bearing (44) in each case of each control linkage (36) remains fixed in position on the associated bracket (46) during the entire adjustment movement of the folding top (18).

4. The folding top as claimed in claim 1, characterized in that the adjustable main bearing (42) in each case of each control linkage (36) is adjustable along a control path (56) of the associated bracket (46).

5. The folding top as claimed in claim 4, characterized in that the control path (56) comprises an essentially arc-shaped sliding guide of the associated main bearing (42).

6. The folding top as claimed in claim 2, characterized in that, in the closed position of the folding top (18), the adjustable front main bearing (42) of each control linkage (36) is arranged in a lower height position.

7. The folding top as claimed in claim 2, characterized in that, in the storage position of the folding top (18) in which it is displaced in relation to the motor vehicle, the adjustable front main bearing (42) of each control linkage (36) is arranged in a lower height position.

8. The folding top as claimed in claim 2, characterized in that, in the storage position of the folding top (18) in which it is accommodated in the folding-top storage space (28), the adjustable front main bearing (42) of each control linkage (36) is arranged in an upper height position.

9. The folding top as claimed in claim 1, characterized in that the folding top (18) comprises at least one fixed roof part (22) and a fixed rear window part (26), which parts are connected pivotably to each other.

10. The folding top as claimed in claim 1, characterized in that each bracket (46) is assigned an adjusting device for adjusting the folding top (18).

11. An open motor vehicle folding top that is adjustable between a closed position covering a passenger cell and a folded storage position for accommodating the folding top in a folding-top storage space, comprising a control linkage on both sides of a motor vehicle body and having two main links that are supported on an associated bracket of the motor vehicle body via a respectively assigned main bearing such that in its folded storage position, the folding top is displaceable in relation to the motor vehicle, and the folding top can be adjusted, wherein at least one main bearing of each control linkage is configured to be movable in relation to at least one of the associated bracket and the associated main link.

12. The folding top as claimed in claim 11, wherein the at least one front main bearing of each control linkage is arranged to be height-adjustable in relation to the associated bracket.

13. The folding top as claimed in claim 11, wherein each control linkage comprises a rear main bearing arranged to remain fixed in position on the associated bracket during all adjustment movement of the folding top.

14. The folding top as claimed in claim 11, wherein the at least one adjustable main bearing of each control linkage is configured to be adjustable along a control path of the associated bracket.

15. The folding top as claimed in claim 14, wherein the control path comprises a substantially arc-shaped sliding guide of the associated main bearing.

16. The folding top as claimed in claim 12, wherein, in the closed position of the folding top, the adjustable front main bearing of each control linkage is arranged to be moved to a lower height position.

17. The folding top as claimed in claim 12, wherein, in the storage position of the folding top in which it is displaced in relation to the motor vehicle, the adjustable front main bearing of each control linkage is arranged to be moved to a lower height position.

18. The folding top as claimed in claim 12, wherein, in the storage position of the folding top in which it is accommodated in the folding-top storage space, the adjustable front main bearing of each control linkage is arranged to be moved to an upper height position.

19. The folding top as claimed in claim 11, wherein the folding top comprises at least one fixed roof part and a fixed rear window part that are connected pivotably to each other.

20. The folding top as claimed in claim 11, wherein each of the associated brackets is assigned an adjusting device for adjusting the folding top.
